(19) United States
(12) Patent Application Publication
(10) Pub. No.: US 2010/0045782 A1
(43) Pub. Date: Feb. 25, 2010

(54) CONTENT REPRODUCING APPARATUS AND METHOD

(76) Inventor: Chihiro Morita, Tokyo (JP)

Correspondence Address: BIRCH STEWART KOLASCH & BIRCH, PO BOX 747, FALLS CHURCH, VA, 22040-0747, US

(21) Appl. No.: 12/502,318

(22) Filed: Jul. 14, 2009

(30) Foreign Application Priority Data
Aug. 25, 2008 (JP) 2008-215100

(51) Int. Cl. H04N 15/00; H04N 11/06

(52) U.S. Cl. 348/51; 348/441; 348/E15.001; 348/E11.007

(57) ABSTRACT

In a content reproducing apparatus for displaying three dimensional image using image data for the right eye and left eye, stored after being downsampled in order to reduce data, a high quality image is obtained even at the scene changes or in still pictures. The content reproducing apparatus includes a similar region detector (20) for detecting, for each region forming part of each of the right image and left image, a region of the same size as said each region, and having image data similar to the image data of said each region, and image interpolation data generating circuit (21) for generating interpolation data by extracting data from the similar region, and a frame synthesizing circuit (22) for interpolation the image interpolation data in the decoded image data for each eye.

### BACKGROUND OF THE INVENTION

1. Field of the Invention

The present invention relates to a content reproducing apparatus and method which can reproduce three-dimensional image data recorded in an optical disk, HDD, or other recording medium, or in a recording apparatus. The invention relates in particular to a content reproducing apparatus and method which can display a three-dimensional image of a high resolution by interpolating the data having been removed by the downsampling, when reproducing a content recorded after downsampling the image data in order to reduce the size of the image data.

2. Description of the Related Art

Three dimensional image display equipment, in which images for the right and left eyes, prepared utilizing the parallax between the right and left eyes, are separately made to be seen by the corresponding eyes, in order to achieve three-dimensional display, has now been put into practical use. This method of three-dimensional image display has now been used in some of the movie theaters, so that further development is expected. When a three-dimensional image is recorded in a digital format, its data size is twice the size of the corresponding two-dimensional image because of the need for separate right and left images. A common method of reducing the data size is to downsample the data by removing every other picture element (pixel) or line, as described by, for example, Nakaya et al. in Japanese Patent Application Publication No. H9-271042 (p. 3, FIG. 2). Downsampling is also referred to as sub-sampling or decimation.

Direct reproduction of such downsampled data inevitably leads to an image with lower resolution than the original image. Nakaya et al. address this problem by performing predictive operations to interpolate the missing pixels, operating separately on the right and left image data.

This type of interpolation does not produce satisfactory results, however, for images with low frame-to-frame correlation, such as moving pictures with frequent scene changes. It also works poorly on still pictures, for which the preceding and following frames provide no additional information.

### SUMMARY OF THE INVENTION

A general object of the present invention is to provide an improved method of interpolation for use with downsampled three-dimensional image data.

A more specific object is to provide a method that does not rely on data from preceding and following frames.

The invention provides a content reproducing apparatus that decodes a compressively coded right image downsampled by a factor of two and a compressively coded left image downsampled by a factor of two and generates output images for a three-dimensional display, the content reproducing apparatus comprising:

an image decoding circuit configured to decode the compressively coded downsampled right image and the compressively coded downsampled left image to obtain a decoded right image and a decoded left image;

a similar region detector configured to detect, for each region of each of the decoded right image and the decoded left image, a region which is of the same size as said each region and which has image data similar to the image data of said each region;

an image interpolation data generating circuit configured to generate interpolation data for each of the decoded right image and the decoded left image by extracting pixel data from the similar region; and

a frame synthesizing circuit configured to interpolate the interpolation data into each of the decoded right image and the decoded left image.

According to the invention, each of the downsampled right image and the downsampled left image is divided into a plurality of regions, and interpolation for the image data of each region is made using image data in a region having data similar to the data of said each region. Accordingly, it is possible to obtain a high display quality even at the scene changes or with still pictures, when displaying the three-dimensional image content with the data size reduced by downsampling.

### BRIEF DESCRIPTION OF THE DRAWINGS

In the attached drawings:

FIG. 1 is a block diagram illustrating the structure of a content reproducing apparatus in a first embodiment of the invention;

FIG. 2 illustrates an arrangement of pixels of the image data used in the first embodiment, before downsampling;

FIGS. 3A and 3B illustrate an example of the manner of downsampling the image data in the first embodiment;

FIG. 4 illustrates an example of the manner of forming a frame of image by combining a downsampled right image and a downsampled left image by disposing them in the right and left sides respectively, according to the first embodiment;

FIG. 5 is a block diagram illustrating an exemplary structure of the right image interpolation circuit in the first embodiment;

FIG. 6 illustrates an example of division of each frame into regions, according to the first embodiment;

FIGS. 7A and 7B illustrate a reference region and a plurality of comparison regions according to the first embodiment;

FIG. 8 illustrates right-left offset vectors obtained for M by N regions shown in FIG. 6;

FIGS. 9A to 9C illustrate an example of the manner of synthesizing the right image data and the right image interpolation data according to the first embodiment;

FIGS. 10A to 10C illustrate an example of the manner of synthesizing the left image data and the left image interpolation data according to the first embodiment;

FIG. 11 illustrates an example of combining the right image frames and left image frames according to the first embodiment;

FIG. 12 illustrates another example of the manner of forming a frame of image by combining the downsampled left image and the downsampled right image by disposing them one on top the other, according to the first embodiment;

FIG. 13 is a block diagram illustrating the structure of a content reproducing apparatus in a second embodiment of the invention;

FIGS. 14A and 14B illustrate an example of the manner of downsampling the image data in the third embodiment;

FIGS. 15A to 15C illustrate an example of the manner of synthesizing the right image data and the right image interpolation data according to the third embodiment;

FIGS. 16A to 16C illustrate an example of the manner of synthesizing the left image data and the left image interpolation data according to the third embodiment;

FIGS. 17A and 17B illustrate an example of the manner of downsampling the image data in the fourth embodiment;

FIGS. 18A to 18C illustrate an example of the manner of synthesizing the right image data and the right image interpolation data according to the fourth embodiment;

FIGS. 19A to 19C illustrate an example of the manner of synthesizing the left image data and the left image interpolation data according to the fourth embodiment;

FIG. 20 is a block diagram illustrating an exemplary structure of the right image interpolation circuit in the fifth embodiment; and

FIGS. 21A to 21C, and FIG. 22 illustrate an example of the manner of synthesizing the right image data and the right image interpolation data according to the fifth embodiment.

### DETAILED DESCRIPTION OF THE INVENTION

Embodiments of the invention will now be described with reference to the attached drawings, in which like elements are indicated by like reference characters. In the following description, as well as in the claims, the term ‘image’ will often be used to mean image data.

### First Embodiment

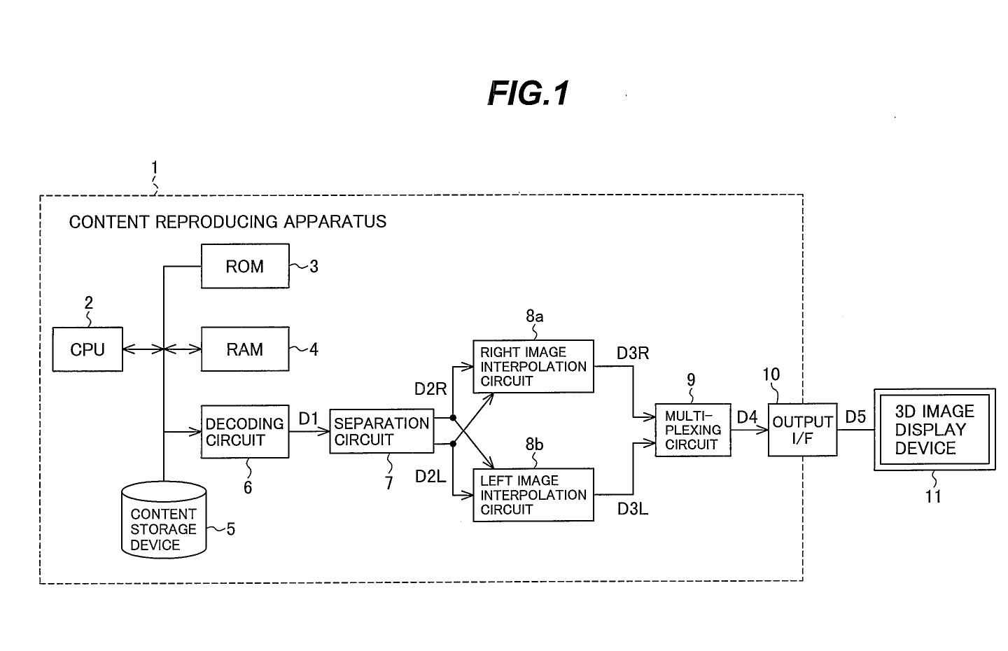

FIG. 1 is a block diagram showing an example of content reproducing apparatus of a first embodiment of the invention. The illustrated content reproducing apparatus 1 has the functions of reproducing a three-dimensional image content that is stored, and provide the reproduced content to a three-dimensional image display apparatus via an interface for video signals, and comprises, as its main components, a central processing unit (CPU) 2, a read-only memory (ROM) 3, a random-access memory (RAM) 4, a content storage device 5, a decoding circuit 6, a separation circuit 7, a right image interpolation circuit 8a, a left image interpolation circuit 8b, a multiplexing circuit 9, and an output interface (I/F) 10.

The content reproducing apparatus 1 reproduces three-dimensional image data that is stored. The ROM 3 is a nonvolatile memory storing programs for controlling the content reproducing apparatus 1. These programs normally include an operating system and various application programs, such as device drivers for controlling various hardware.

The CPU 2 controls the content reproducing apparatus 1 by executing the programs stored in the ROM 3. The RAM 4 is used as a work area and as a buffer for temporarily storing content data, for processing the content data being reproduced.

The content storage device 5 is for storing three-dimensional image data, and is a nonvolatile data storage device such as a magnetic disk in a hard disk drive, or an optical disc such as a digital versatile disc (DVD) or a Blu-ray disc. The three-dimensional image data stored in the content storage device 5 have been compressed by a compressive video coding method such as the MPEG-2 method developed by the Moving Picture Experts Group or the H.264 method developed by the Video Coding Experts Group.

The decoding circuit 6 decompresses and decodes the compressively coded data stored in the content storage device 5 to obtain three-dimensional decoded image data D1 comprising values for individual pixels.

The separation circuit 7 separates the three-dimensional image data having been decoded by the decoding circuit 6, into image data for right eye (right image data) D2R and image data for left eye (left image data) D2L. Each of the right image data D2R and left image data D2L is supplied to both of the right and left image interpolation circuits 8a and 8b.

The right image interpolation circuit 8a performs interpolation using the input right image data D2R and the left image data D2L, to generate an interpolated right output image D3R.

The left image interpolation circuit 8b performs interpolation using the input left image data D2L and the right image data D2R, to generate an interpolated left output image D3L.

The multiplexing circuit 9 multiplexes the interpolated right image data D3R and the interpolated left image data D3L for transmission to the three-dimensional image display device 11.

The output interface 10 transmits the multiplexed right image data and left image data (D4) to the three-dimensional image display device 11. Used as the output interface 10 is one according to a digital video and audio input/output interface standards, such as the high-definition multimedia interface (HDMI) format.

The three-dimensional image display device 11 is a monitor device which displays the input right image data and the input left image data on a screen so that the right image data is seen only by the right eye of the viewer while the left image is seen only by the left eye of the viewer. This may be implemented by a scheme in which the right image and the left image are displayed on a screen as images having components polarized in mutually orthogonal directions, and the viewer wear glasses with correspondingly polarized elements so that the images are separated and are incident on the respective eyes. In another scheme, the right image and the left image are displayed alternately, being switched every frame, and the viewer wears glasses with shutters switched in synchronism with the switching of the output images.

The operation of the embodiment 1 of the invention will now be described.

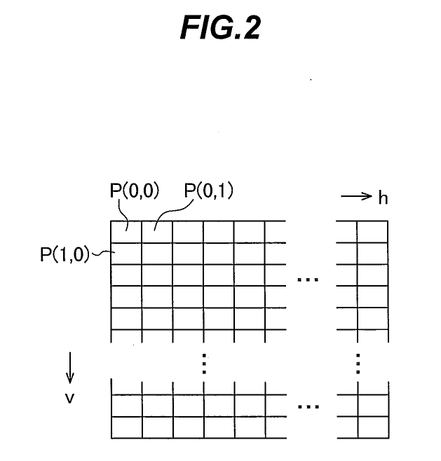

In the following description, each pixel in a frame is denoted by P(v,h), with vertical coordinate v and horizontal coordinate h, where v and h are integers. In the original image data (image data before the downsampling), the pixels are arranged in a matrix with horizontal lines (rows) and vertical lines (columns), as shown in FIG. 2. In such an image data, the origin of the coordinate system (v=0, h=0) is in the top left corner, v increases by one per pixel in the downward direction, and h increases by one per pixel toward the right.

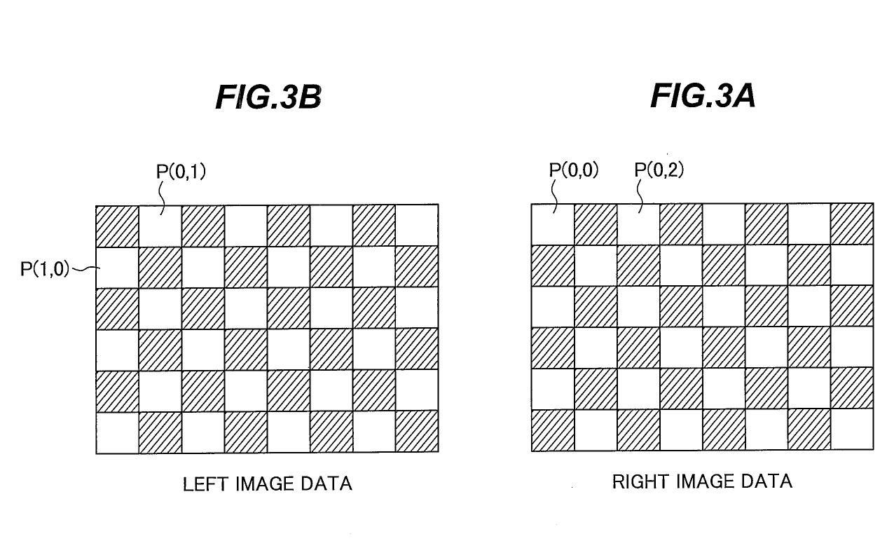

The downsampled image data is in a checkerboard pattern as shown in FIGS. 3A and 3B, and is obtained by downsampling in such a manner that every other pixel in each horizontal line is removed, and every other pixel in each vertical line is removed. In other words, each of the downsampled right image and the downsampled left image alternately includes and excludes the pixels in each horizontal line (row) and alternately includes and excludes the pixels in each vertical line (column).

In the example shown in FIGS. 3A and 3B, white parts (squares) indicate the pixels which are downsampled (retained after the decimation), while hatched parts indicate the pixels which are removed. In the illustrated example, the positions of the downsampled pixels in the right image data and the positions of the downsampled pixels in the left image data are shifted relative to each other. The downsampled right image, shown in FIG. 3A, consists of pixels P(0,1), P(0,3), . . . , P(1,0), P(1,2), P(1,4), . . . and so on. The downsampled left image, shown in FIG. 3B, consists of pixels P(0,0), P(0,2), P(0,4), . . . , P(1,1), P(1,3), . . . and so on.

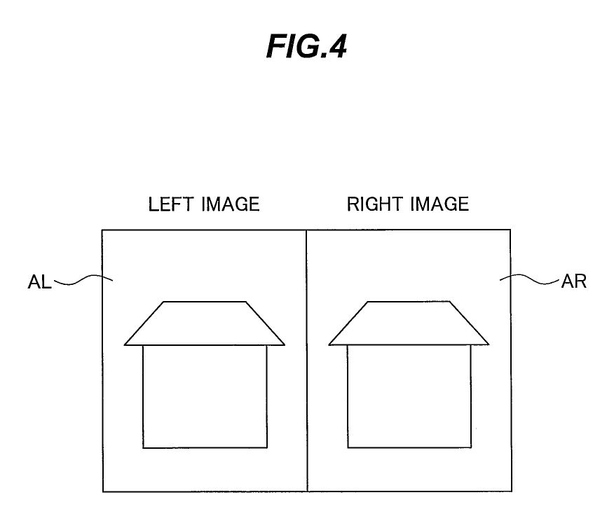

The right image data and the left images are squeezed horizontally and packed together as shown in FIG. 4, so that the left image occupies the left half AL of a frame, the right image occupies the right half AR of the same frame, to form the frame. Frames of this type are compressively coded according to a predetermined image coding/compression scheme, and stream data obtained by multiplexing the compressed data and audio data is stored in a content storage device 5. The stream data is a normal audio-video stream except that the video part consists of horizontally squeezed right and left images placed side by side, representing the same scene as it would be seen at the same time by the right and left eyes.

During reproduction, the CPU 2 reads the stream data from the content storage device 5, separates the video data from the audio data, and supplies the video data to the decoding circuit 6.

The decoding circuit 6 decompresses and decodes the video data, according to the predetermined video coding/compression scheme, to obtain a series of frames of the decompressed image data D1 of the type shown in FIG. 4.

The separation circuit 7 separates each frame of image data D1 into the right image and the left image, and outputs the right image data D2R and the left image data D2L. The number of pixels in the horizontal direction of each of the right image data D2R and the left image data D2L is half that of the original image data D1 (image data before the separation). For simplicity, these half-frames may also be referred to simply as “data frames” below.

The right image data D2R and the left image data D2L are both input to the right image interpolation circuit 8a and to the left image interpolation circuit 8b.

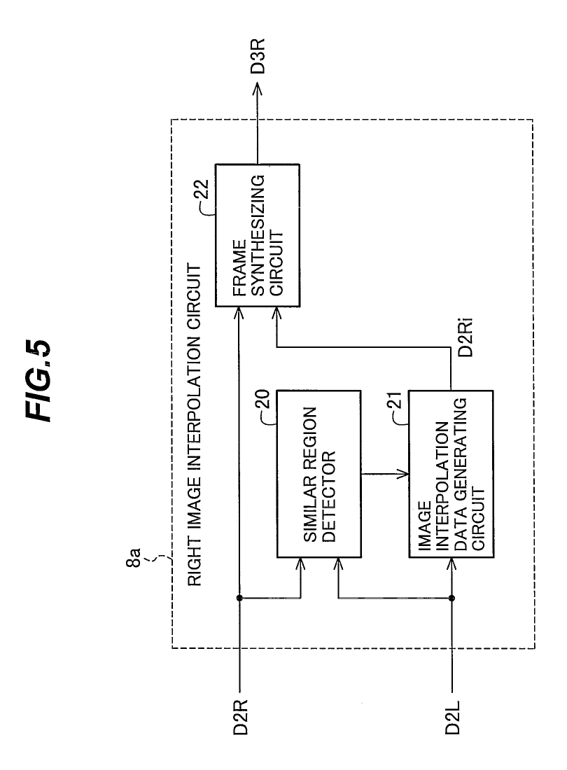

The right image interpolation circuit 8a uses the right image data D2R and the left image data D2L to conduct interpolation for the right image D2R to thereby generate the right output image D3R. Similarly, the left image interpolation circuit 8b uses the left image data D2L and the right image data D2R to conduct interpolation for the left image D2L to thereby generate the left output image D3L. The operation of the right image interpolation circuit 8a will be described below with reference to FIG. 5. The operation of the left image interpolation circuit 8b is similar.

As shown in FIG. 5, the right image interpolation circuit 8a comprises a similar region detector 20, an interpolation data generating circuit 21, and a frame synthesizing circuit 22. Both of the right image data D2R and the left image data D2L extracted from the same frame (that is, the right image data D2R and the left image data D2L contemporaneous with each other) are supplied to the similar region detector 20. The right image data D2R is also input to the frame synthesizing circuit 22.

The similar region detector 20 divides each frame of the right image data D2R into a plurality of regions (blocks) of equal size, selects (takes) each of these right regions in turn as a reference region, searches the left image data D2L separated from the same frame as the reference region, to find a similar region of the same size in the left image data D2L. In the present application, the similar region is also called “corresponding region.” For instance, the region with the maximum similarity among the regions at the same vertical position as the reference region, within the frame is detected as the corresponding region. The similar region detector 20 further detects the relative position of the corresponding region with respect to the reference position as the right-left offset vector. The “relative position” is represented by the difference between the position of the reference region within the right image part (right half-frame area) AR and the position of the corresponding region within the left image part (left half-frame area) AL as shown in FIG. 4.

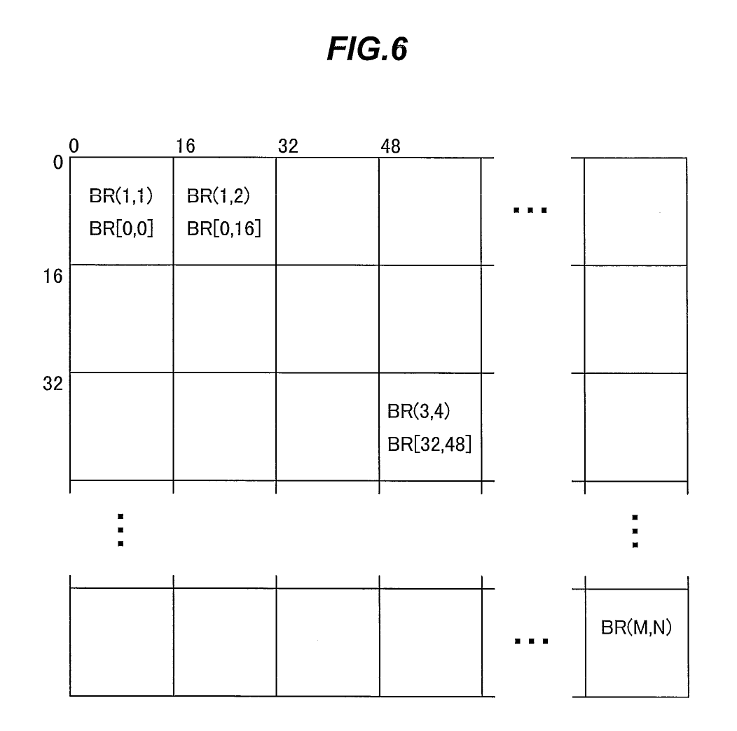

In the following description, the regions are square regions (blocks), each measuring sixteen pixels vertically and sixteen pixels horizontally. For instance, in the case of a right image, the regions are denoted by BR(m,n), according to the position within the frame, as shown schematically in FIG. 6, where m and n are positive integers that increase by one per region (per 16 pixels) in the downward and right directions. For the region at the top left corner, m=1 and n=1. In the illustrated example, each frame is divided into M regions in the vertical direction and N regions in the horizontal direction. Each region is also denoted by BR[v,h] using square brackets, when the pixel at the top left corner of the region is represented by P(v,h). Similar notation BL(m,n) and BL[v,h] will be used to denote the left regions in the left image.

The region having the maximum similarity among the regions of the same size (16 pixels in each of the vertical and horizontal directions) in the left image data frame is detected as the corresponding region. For this purpose, the regions of the same size are successively selected as comparison regions, from the left image data frame, and the similarity to the reference region is calculated for each of the comparison regions, and the region having the maximum similarity is detected as the corresponding region.

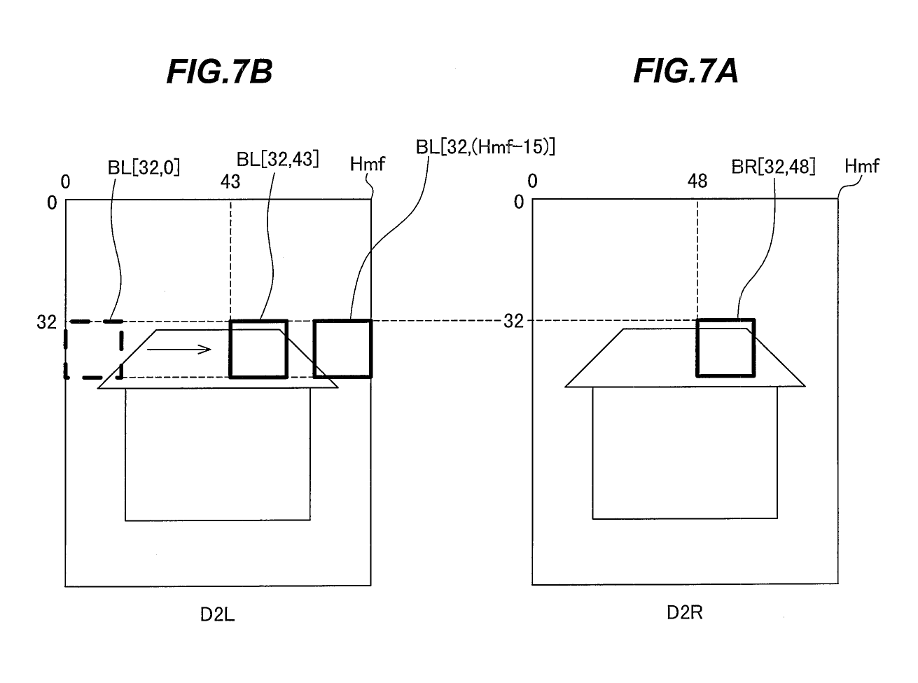

In the example under consideration, the comparison regions are limited to those at the same vertical position as the reference region BR as shown in FIGS. 7A and 7B, and selected in turn, with the horizontal position being shifted one pixel at a time. As a result, the right-left offset vector will be detected with a resolution of one pixel. In the example shown in FIGS. 7A and 7B, the reference region is BR(3,4), i.e., BR[32,48] (because the pixel in its top left corner is denoted by P(32,48)), and as the comparison regions, all the regions in the same vertical position in the left image are taken (selected) as comparison regions in turn, starting with the leftmost region BL[32,0], which has pixel P(32,0) in its top left corner, then moving one pixel to the right to consider the region BL[32,1] having pixel P(32,1) in its top left corner, and proceeding in this way through the region BL[32, Hmf-15] having pixel P(32, Hmf-15) in its top left corner, where Hmf is the horizontal coordinate of the pixel at the right edge of the frame.

The reason for testing only regions in the same vertical position as the reference region is that the right and left images are normally created with horizontal parallax.

The similar region detector 20 calculates the similarity of each region tested (selected) successively, and selects a region having the maximum similarity as the corresponding region. The similar region detector 20 regards the difference (relative position) of the position of the corresponding region within the left image data frame (the left image part) from the position of the reference region within the right image data frame (right image part), as the right-left offset vector. For example, if region BL[32,43] in FIG. 7B is the region most similar to region BR[32,48] in FIG. 7A, then the right-left offset vector of region BL[32,43] has the value (32-32, 43-48) or (0, −7). Since this is the right-left offset vector of region BR(3,4), it may also be denoted V(3,4), and the outcome of the search can expressed as V(3,4)=(0,−7).

The similarity of a comparison region in the left image to the reference region in the right image is determined by calculating a sum Ds of absolute differences of the values of pixels in corresponding positions (differences of the values of the pixels in the comparison region and the corresponding pixels in the reference region (differences of the values of the pixels at the same relative positions within the respective regions)). The sum of absolute differences, Ds, is expressed by the following formula.

$$Ds = {\sum }_{v , h ∈ {B}_{R}} \vert {S}_{L} ( v , h + v ) - {S}_{R} ( v , h ) \vert \qquad ( 1 )$$

In this formula v and h are vertical and horizontal pixel coordinates within the frame, ν is an offset added to the horizontal coordinate (relative position of the comparison region with respect to the reference position), B_{R} denotes the reference region in the right image, S_{R}(v,h) is the value of the pixel with coordinates (v,h) in the reference region B_{R} in the right image, and S_{L}(v,h+ν) is the value of the pixel with coordinates (v,h+ν) in the comparison region (region being tested) in the left image.

{S_{L}(v,h+ν)−S_{R}(v,h)}

in the equation (1) represents the difference between the value S_{R}(v,h) of a pixel in the reference frame and the value S_{L}(v,h+ν) of a corresponding pixel in the comparison frame.

The offset ν is varied to test different regions in the left image until all regions in the same vertical position as the reference region have been tested. The value of ν that gave the minimum difference Ds is then output as the horizontal coordinate of the right-left offset vector.

In a color image, the Ds calculation may be performed separately for the different components of the image data (e.g., for the luminance, blue color difference, and red color difference components, or for the red, green, and blue components) and the three resulting Ds values may be added together to select a single corresponding region. That is, the region with which the result of the addition of three Ds values is minimum may be selected as the corresponding region. Alternatively, a separate corresponding region may be selected for each component.

The similar region detector 20 divides each frame of the right image D2R into regions of 16×16 pixels, takes each of the divided regions as a reference region, and calculates the right-left offset vector for each of the reference regions. The calculated right-left offset vectors are stored in a memory (not shown) in the similar region detector 20, or in the RAM 4.

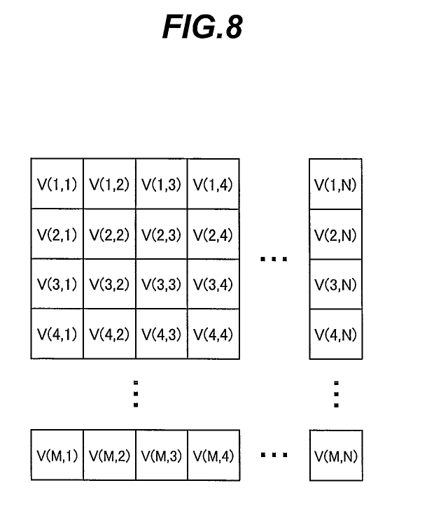

In the example shown in FIG. 8, the right-left offset vector v(m,n) (m=1 to M, n=1 to N) is determined for each of the M×N regions shown in FIG. 6, and stored.

After calculating right-left offset vectors for all the reference regions, the similar region detector 20 outputs the right-left offset vectors to the interpolation data generating circuit 21.

The interpolation data generating circuit 21 uses the right-left offset vectors V(m,n) received from the similar region detector 20, and the left image data D2L which is contemporaneous with the data used for the calculation of the right-left offset vectors, to extract, from the left image data D2L, pixel data of the region of 16×16 pixels at the position designated by (at the relative position represented by) the right-left offset vector v(m,n) for each reference region, and assembles the extracted regions, into a frame of right interpolration data D2Ri. The right interpolation data D2Ri thus generated are made up of 16×16 (sixteen-by-sixteen) pixel regions that were found by the similar region detector 20 to be most similar to the reference regions in the respective (corresponding) positions in the right image data D2R. The interpolation data generating circuit 21 outputs the right interpolation data D2Ri to the frame synthesizing circuit 22.

The frame synthesizing circuit 22 receives the right interpolation data D2Ri together with the contemporaneous right image data D2R from which the right-left offset vectors were calculated.

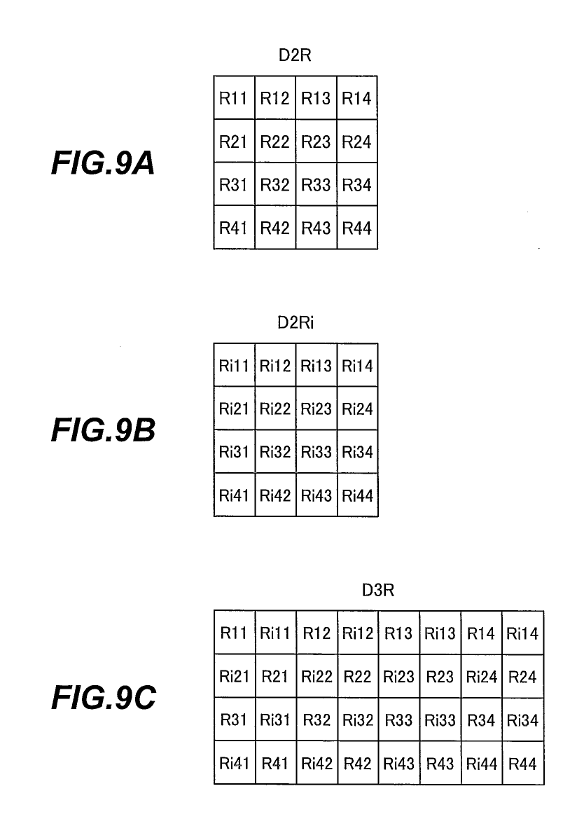

The frame synthesizing circuit 22 arranges the right image data D2R and the right image interpolation data D2Ri so that their pixels are disposed alternately in the horizontal and vertical directions, i.e., the pixels of the right image data D2R are disposed at alternate pixel positions in each row and at alternate pixel positions in each column, and the pixels of the right image interpolation data D2Ri are disposed at intervening pixel positions in each row and at intervening pixel positions in each column. The manner of the arrangement is shown in FIGS. 9A to 9C. In these figures, it is assumed, for simplicity of illustration, that the reference region and the comparison region are both of the size of 4×4 (four-by-four) pixels. These figures illustrate the manner of synthesizing the right image data D2R (R11 to R44) of 4×4 pixel size shown in FIG. 9A and the right image interpolation data D2Ri (Ri11 to Ri44) of 4×4 pixel size shown in FIG. 9B to form interpolated right image data D3R of 8×4 pixel size shown in FIG. 9C.

In the synthesis, in the odd-numbered rows within the region as counted from the top, the right image interpolation data (Ri11, Ri12, . . . ) are disposed at the right of the corresponding right image data (Ri11, R12, . . . ), while in the even-numbered rows, the right image interpolation data (Ri21, Ri22, . . . ) are disposed at the left of the corresponding right image data (R21, R22, . . . ). Here, the term “corresponding” means that they are at the same position in the arrangement of the right image data D2R and the right image interpolation data D2Ri shown in FIGS. 9A and 9B.

As a result, the pixels of the right image data D2R and the right image interpolation data D2Ri are disposed in a checkerboard pattern (at every other pixel position in the vertical and horizontal directions), and the interpolated right image data D3R has a horizontal resolution which is doubled (and which is the same as the resolution before the downsampling). Among the interpolated right image data D3R, those corresponding to the right image data (R11, R12, . . . ) are at the same positions as the data of the pixels retained after the downsampling (i.e., the positions of the white parts in FIG. 3A), and those corresponding to the right image interpolation data (Ri11, Ri12, . . . ) are at the same positions as the data of the pixels removed by the downsampling (i.e., the positions of the hatched parts in FIG. 3A).

Because the above-described synthesis is performed for the entire frame, the interpolated right image data (the right image data after the synthesis) has a horizontal resolution which is doubled.

Description has been made on the right image interpolation circuit 8a with reference to FIG. 5. The left image interpolation circuit 8b shown in FIG. 1 is of the same configuration as the right image interpolation circuit and operates in the same way as the right image interpolation circuit 8a to produce interpolated left image data D3L. The above description with reference to FIGS. 5 to 9C is applicable if the words “right” and “left” are interchanged, and the reference symbols “R” and “L” are interchanged.

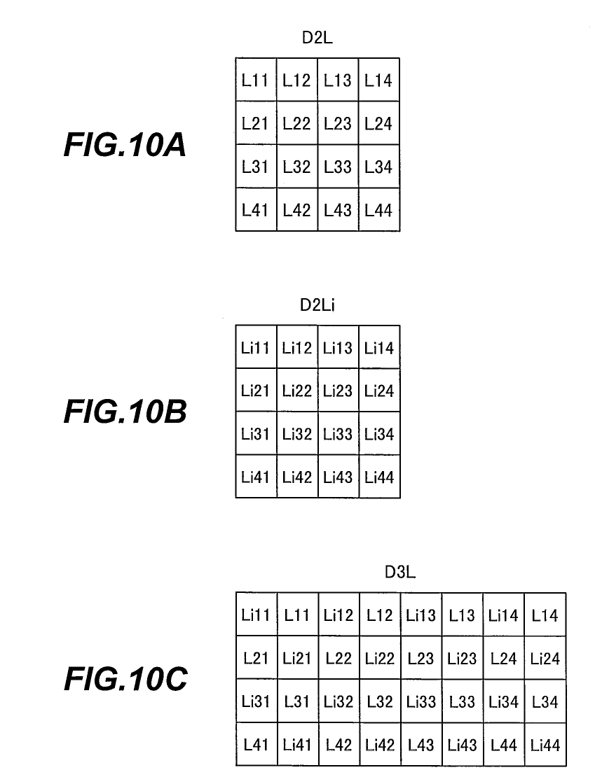

The operation of the frame synthesizing circuit 22 in the left image interpolation circuit 8b is shown in FIGS. 10A to 10C.

The frame synthesizing circuit 22 in the left image interpolation circuit 8b arranges the left image data D2L and the left image interpolation data D2Li so that their pixels are disposed alternately in the vertical and horizontal directions, i.e., the pixels of the left image data D2L are disposed at alternate pixel positions in each row and at alternate pixel positions in each column, and the pixels of the left image interpolation data D2Li are disposed at intervening pixel positions in each row and at intervening pixel positions in each column).

Like FIGS. 9A to 9C, FIGS. 10A to 10C assume the regions of the size of 4×4 pixels, and illustrate the manner of synthesizing the left image data D2L (L11 to L44) of 4×4 pixel size shown in FIG. 10A and the left image interpolation data D2Li (Li11 to Li44) of 4×4 pixel size shown in FIG. 10B to form interpolated left image data D3L of 8×4 pixel size shown in FIG. 10C. In the synthesis, in the odd numbered rows within the region as counted from the top, the left image interpolation data (Li11, Li12, . . . ) are disposed at the left of the corresponding left image data (L11, L12, . . . ), while in the even numbered rows, the left image interpolation data (Li21, Li22, . . . ) are disposed at the right of the corresponding left image data (L21, L22, . . . ).

As a result, the pixels of the left image data D2L and the left image interpolation data D2Li are disposed in a checkerboard pattern (at every other pixel position in the vertical and horizontal directions), and the interpolated left image data D3L has a horizontal resolution which is doubled (and which is the same as the resolution before the downsampling). Among the interpolated left image data D3L, those corresponding to the left image data (L11, L12, . . . ) are at the same positions as the data of the pixels retained after the downsampling (i.e., the positions of the white parts in FIG. 3B), and those corresponding to the left image interpolation data (Li11, Li12, . . . ) are at the same positions as the data of the pixels removed by the downsampling (i.e., the positions of the hatched parts in FIG. 3B).

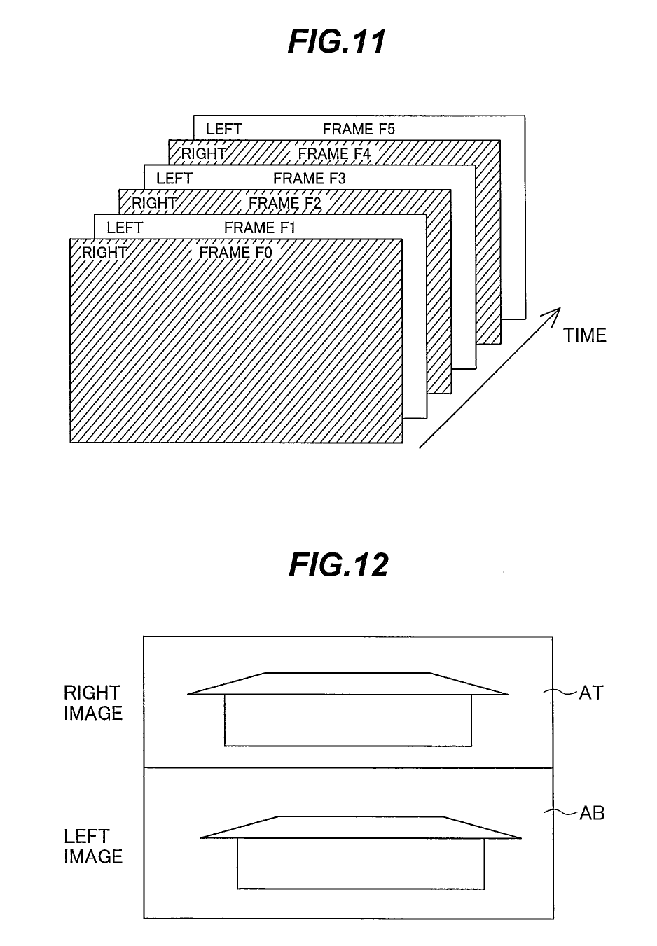

The image data D3R output from the right image interpolation circuit 8a and the image data D3L output from the left image interpolation circuit 8b are supplied to the multiplexing circuit 9. The multiplexing circuit 9 arranges the input image data D3R and the image Data D3L alternately in the temporal direction so that the right image data frames alternate with the left image data frames, to form a multiplexed image stream. This is illustrated in FIG. 11. In the illustrated example, an even numbered frame and an odd numbered frame which are produced one after another (e.g., frame F0 and frame F1) form a pair of images for right and left eyes to construct a three-dimensional image. (In other words, in the illustrated sequence, the right image in frame F0 is contemporaneous with the left image in frame F1, the right image in frame F2 is contemporaneous with the left image in frame F3, and so on.) In such a case, if the frame rate of the original image is 30 fps, then the frame rate for the transmission of the frames of the images for the right and left eyes will be 60 fps because the images for the right and left eyes are transmitted in a multiplexed form.

The multiplexed image data D4 output from the multiplexing circuit 9 is passed through the interface 10 and transmitted as the image data D5 to the three-dimensional image display device 11.

The three-dimensional image display device 11 receives the image data D5, and displays the right image data and the left image data on a screen, so that the right image is made to be seen by the right eye only, and the left image is made to be seen by the left eye only. This may be achieved by using glasses with polarizers to separate the image into right and left eyes, or by displaying the right image frames and left image frames alternately and using glasses provided with shutters and switching the shutters for right and left eyes alternately in synchronism with the alternate display of the right image frames and left image frames. With the configuration described above, it is possible to obtain a high display quality at the time of displaying the three-dimensional image content with the data sized reduced by downsampling.

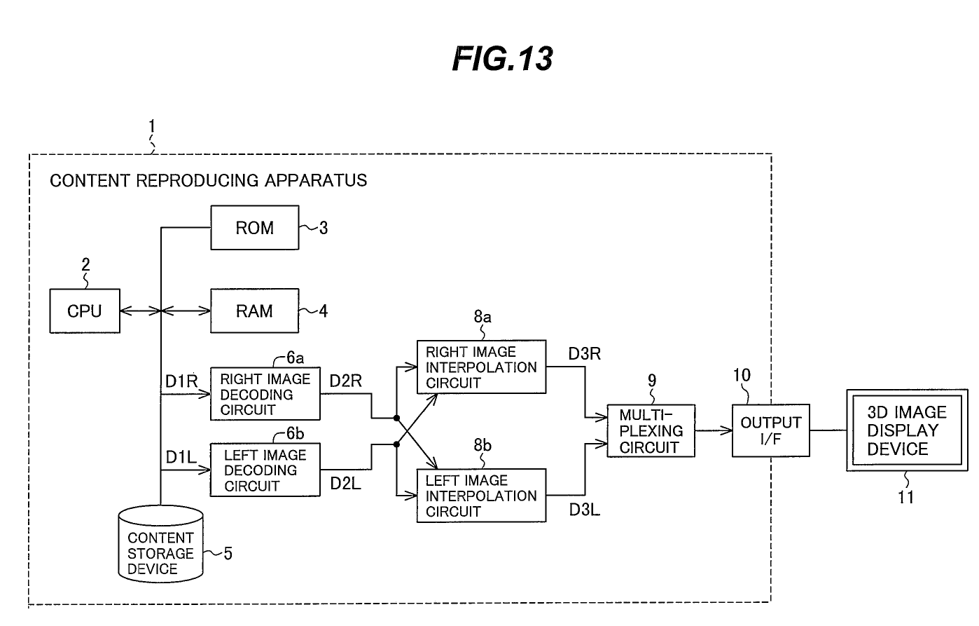

In the embodiment described, the pixels of the downsampled right image are squeezed horizontally and packed in the right half, and the pixels of the downsampled left image are squeezed horizontally and packed in the left half. Alternatively, the pixels of the downsampled right image may be packed in the left half, and the pixels of the downsampled left image may be packed in the right half. Still alternatively, the pixels of the downsampled right image and the left image may be squeezed vertically, and, as shown in FIG. 12, the pixels of the right image may be packed in a region AT in the upper half, while the pixels of the left image may be packed in a region in the lower half. Conversely, the pixels of the left image may be packed in a region AT in the upper half, while the pixels of the right image may be packed in a region in the lower half.

Instead of producing a right image interpolation data by searching the left image to detect a corresponding region most similar to a reference region in the right image, a most similar region may be extracted from a right image and used as a corresponding region for the reference image. Similarly, a left image interpolation data may be produced by searching the left image and detecting a corresponding region most similar to a reference region in the left image, instead of searching the right image.

Instead of producing a right image interpolation data by searching the frame contemporaneous with the reference region to find the corresponding region for the reference region, a corresponding region may be detected from different frames, e.g., preceding and following frames.

Instead of detecting a region with a smallest sum of absolute differences as a corresponding region, other regions, such as a region with a second smallest sum of absolute differences, or a region a third smallest sum of absolute differences, may be detected and used as a corresponding region.

### Second Embodiment

The content reproducing apparatus according to the first embodiment is suitable to a situation in which the content storage device 5 stores the data obtained by compressing the pixels of the downsampled right image and the pixels of the downsampled left image into a single frame. Next, description is made of a content reproducing apparatus which is suitable to a situation in which the content storage device 5 stores the data obtained by forming a single frame from a downsampled right image and another single frame from a downsampled left image, and compressing the respective images separately according to a predetermined image coding/compression scheme.

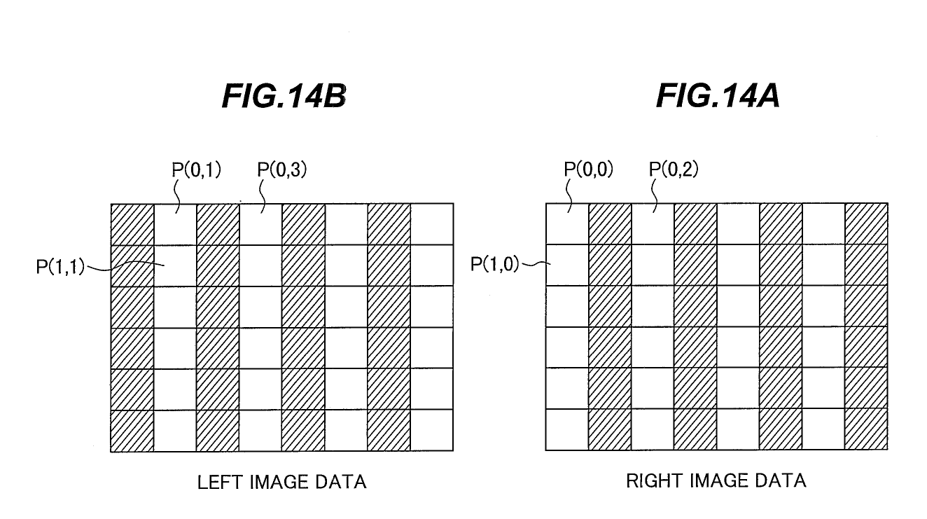

FIG. 13 is a block diagram showing an example of a content reproducing apparatus according the second embodiment of the invention. Differences from the configuration described in connection with the first embodiment referring to FIG. 1 are that the decoding circuit 6 shown in FIG. 1 is replaced by a right image decoding circuit 6a for decoding the right image and a left image decoding circuit 6b for decoding the left image are provided separately from each other. Moreover, since the decoding circuits 6a and 6b are provided separately, no separation circuit (separation circuit 7 in FIG. 1) is provided.

Description is now made of the operation of the second embodiment.

It is assumed that the right image data and the left image data are obtained by downsampling in a checkerboard pattern as shown in FIGS. 3A and 3B, as in the first embodiment.

The downsampled right image is treated as a single frame, and the downsampled left image is treated as another single frame. That is, the right and left images are treated as separate data. The right image data and the left image data are compressed according a predetermined image coding/compression scheme, and multiplexed with audio data, to produce stream data, which is then stored in the content storage device 5.

During reproduction, the CPU 2 reads the stream data stored in the content storage device 5, and separates the stream data into the right image data D1R and the left image data D1L, and supplies the right image data D1R to the right image decoding circuit 6a and supplies the left image data D1L to the left image decoding circuit 6b.

The right image decoding circuit 6a decompresses and decodes the input image data, according to a predetermined image coding/compression scheme, and supplies the decoded right image data D2R to the right image interpolation circuit 8a and the left image interpolation circuit 8b.

Similarly, the left image decoding circuit 6b decompresses and decodes the input image data, according to a predetermined image coding/compression scheme, and supplies the decoded left image data D2L to the right image interpolation circuit 8a and the left image interpolation circuit 8b.

The operations in the subsequent stages are similar to those described in connection with the first embodiment. It is possible, as in the first embodiment, to achieve display of a high display quality in displaying the three-dimensional content with the data size reduced by downsampling the pixels.

### Third Embodiment

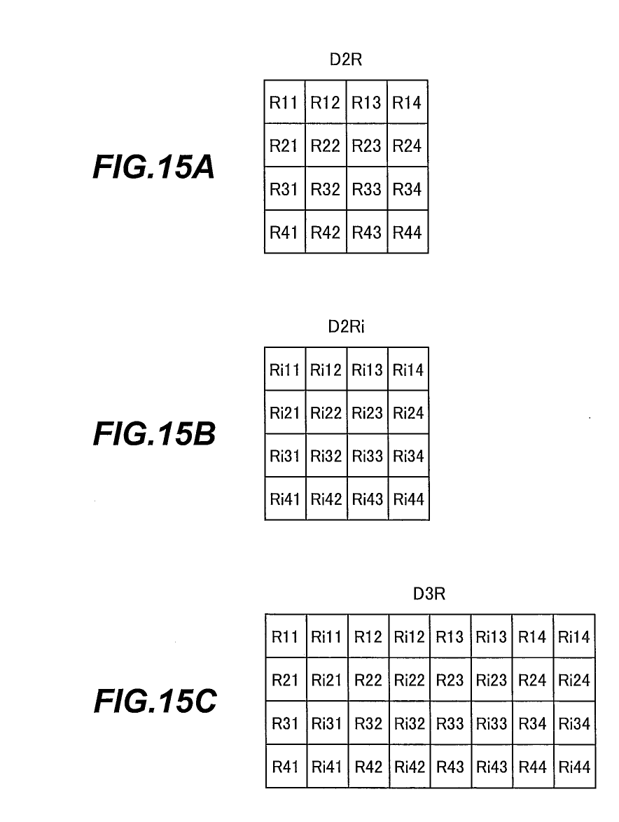

In the first and second embodiments, the downsampling is made in a checkerboard pattern, by removing every other pixel in vertical and horizontal directions, as shown in FIGS. 3A and 3B. It is also possible to remove data of every other vertical line (column), as shown in FIGS. 14A and 14B.

In FIGS. 14A and 14B, the white parts indicate the pixels which are retained after the decimation, while hatched parts indicate the pixels which are removed. In the illustrated example, the lateral positions of the pixels (lines) which are retained after downsampling the right image and the pixels (lines) of the left image which are retained after downsampling the left image are shifted by one pixel (one column) relative to each other.

In the third embodiment, the content reproducing apparatus shown in FIG. 1 or the content reproducing apparatus shown in FIG. 13 may be used. In the following description, it is assumed that the content reproducing apparatus shown in FIG. 1 is used.

It is also assumed that the pixels of the right image data and the pixels of the left image data after the decimation are squeezed laterally (horizontally), and the pixels of the right image are packed in the right half and the pixels of the left image are packed in the left half, as shown in FIG. 4, to form a single frame of data, which is then compressed according to a predetermined coding/compression scheme, and the compressed data is multiplexed with the audio data to form stream data, which is then stored in the content storage device 5.

During reproduction, the CPU 2 reads the stream data stored in the content storage device 5, and supplies the right image data D2R to the left image data D2L to the right image interpolation circuit 8a and the left image interpolation circuit 8b, as in the first embodiment.

In the operation of the right image interpolation circuit 8a, the right image interpolation data D2Ri is generated by the image interpolation data generating circuit 21 and supplied to the frame synthesizing circuit 22, as in the first embodiment. Due to the different downsampling pattern, however, the interpolation data are inserted into the decoded image data in a different way.

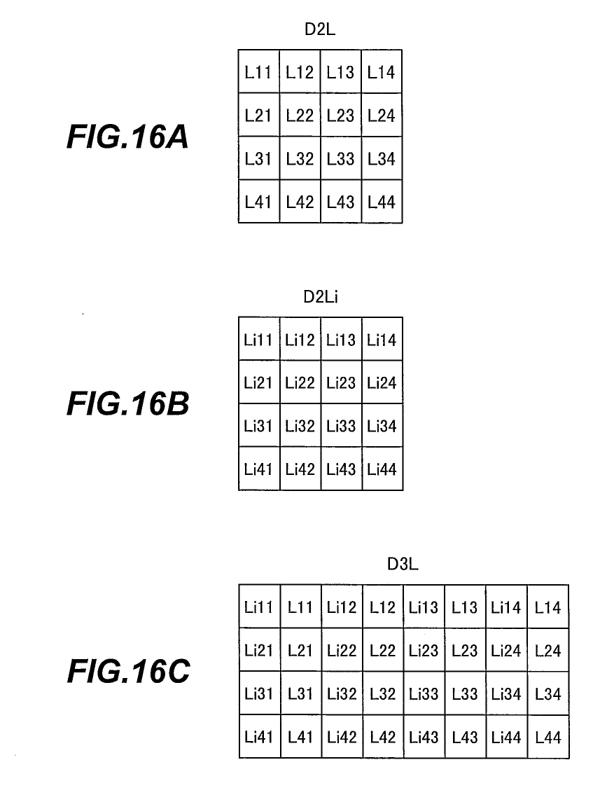

The frame synthesizing circuit 22 arranges the right image data D2R and the right image interpolation data D2Ri so that their pixels are disposed alternately in the lateral direction, i.e., the right image data D2R occupy alternate vertical lines (columns) while the right image interpolation data D2Ri occupy the intervening vertical lines (columns). The manner of the arrangement is shown in FIGS. 15A to 15C. These figures assume the regions of the size of 4×4 pixels, for simplicity of illustration, and illustrate the manner of synthesizing the right image data D2R (R11 to R44) of 4×4 pixel size shown in FIG. 15A and the right image interpolation data D2Ri (Ri11 to Ri44) of 4×4 pixel size shown in FIG. 15B to form interpolated right image data D3R of 8×4 pixel size shown in FIG. 15C. In the synthesis, the right image interpolation data (Ri11, Ri12, . . . ) are disposed at the right of the corresponding right image data (R11, R12, . . . ). As a result, the pixels of the right image data D2R are disposed in alternate columns while the pixels of the right image interpolation data D2Ri are disposed in intervening columns, and the interpolated right image data D3R has a horizontal resolution which is doubled (and which is the same as the resolution before the downsampling). Among the interpolated right image data D3R, those corresponding to the right image data (R11, R12, . . . ) are at the same positions as the data of the pixels retained after the downsampling (i.e., the positions of the white parts in FIG. 14A), and those corresponding to the right image interpolation data (Ri11, Ri12, . . . ) are at the same positions as the data of the pixels removed by the downsampling (i.e., the positions of the hatched parts in FIG. 14A).

The left image interpolation circuit 8b is of the same configuration as the right image interpolation circuit 8a and performs the same operation as the right interpolation circuit 8a to produce interpolated left image data D3L, and the above description with reference to FIGS. 5 to 8, FIGS. 14A and 14B, and FIGS. 15A to 15C is also applicable, if the words “right” and “left” are interchanged, and the symbols “R” and “L” are interchanged in the description.

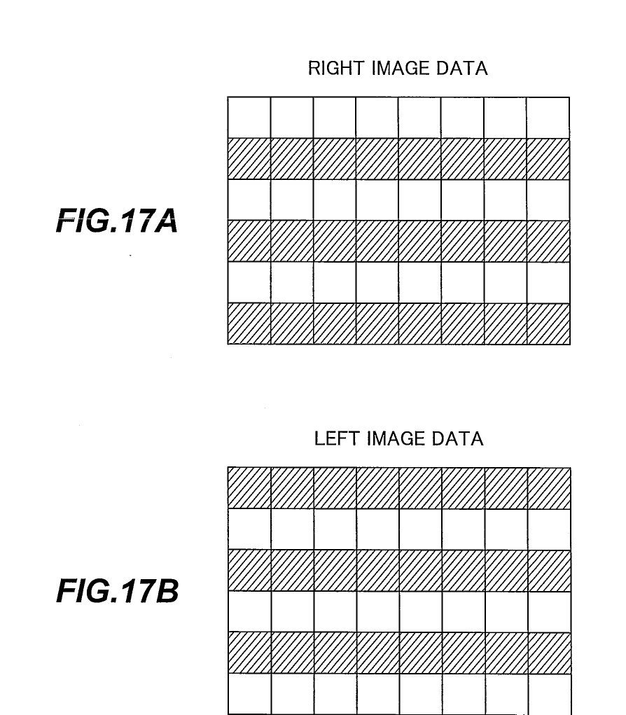

The operation of the frame synthesizing circuit 22 in the left image interpolation circuit 8b in the third embodiment is shown in FIGS. 16A to 16C.

The frame synthesizing circuit 22 in the left image interpolation circuit 8b arranges the left image data D2L and the left image interpolation data D2Li so that their pixels are disposed alternately in the lateral direction, i.e., the left image data D2L occupy alternate lines (columns) while the left image interpolation data D2Li occupy the intervening vertical lines (columns). Like FIGS. 15A to 15C, FIGS. 16A to 16C assume the regions of the size of 4×4 pixels, and illustrate the manner of synthesizing the left image data D2L (L11 to L44) of 4×4 pixel size shown in FIG. 16A and the left image interpolation data D2Li (Li11 to Li44) of 4×4 pixel size shown in FIG. 16B to form interpolated left image data D3L of 8×4 pixel size shown in FIG. 16C. In the synthesis, the left image interpolation data (Li11, Li12, . . . ) are disposed at the left of the corresponding left image data (L11, L12, . . . ). As a result, the pixels of the left image data D2L are disposed in alternate columns while the pixels of the left image interpolation data D2Li are disposed in intervening columns, and the interpolated left image data D3L has a horizontal resolution which is doubled (and which is the same as the resolution before the downsampling). Among the interpolated left image data D3L, those corresponding to the left image data (L11, L12, . . . ) are at the same positions as the data of the pixels retained after the downsampling (i.e., the positions of the white parts in FIG. 14B), and those corresponding to the left image interpolation data (Li11, Li12, . . . ) are at the same positions as the data of the pixels removed by the downsampling (i.e., the positions of the hatched parts in FIG. 14B).

The operations subsequent to the output of the interpolated right image data D3R by the right image interpolation circuit 8a and the output of the interpolated left image data D3L by the left image interpolation circuit 8b are similar to those described in connection with the first embodiment. That is, the right output image data D3R and left output image data D3L are combined and displayed as described in the first embodiment.

According to the third embodiment, it is possible to obtain a high display quality when displaying a three-dimensional image content with the data size reduced by downsampling, as was also described in connection with the first embodiment.

The method described in connection with the third embodiment can be applied to a situation where the downsampled right image is made to form a single frame, and the downsampled left image is made to form another single frame, and the right and left images are compressed separately according to a predetermined image coding/compression scheme.

### Fourth Embodiment

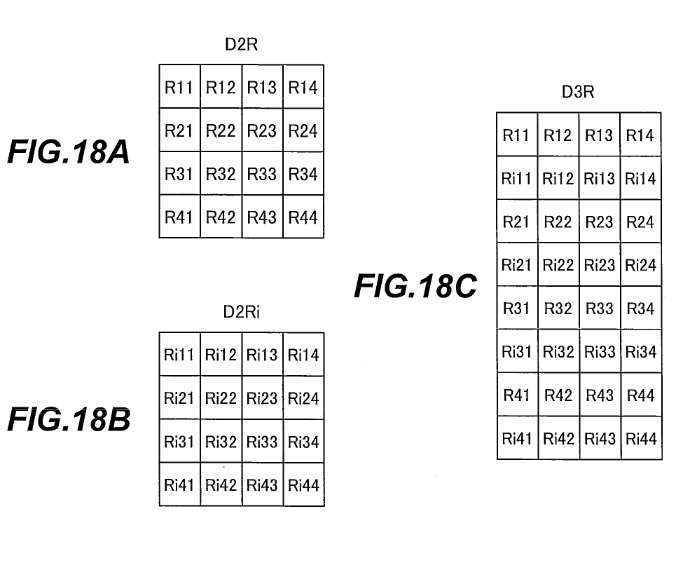

In the third embodiment, the data is removed at every other vertical line as shown in FIGS. 14A and 14B. It is also possible to remove the data at every other horizontal line (row) as shown in FIG. 17A and 17B.

In FIGS. 17A and 17B, the white parts indicate the pixels retained after the downsampling, while hatched parts indicate the pixels which are removed. In the illustrated example, the vertical positions of the downsampled pixels (lines) of the right image data and the downsampled pixels (lines) of the left image data are shifted by one pixel (row) relative to each other.

The content reproducing apparatus shown in FIG. 1 or the content reproducing apparatus shown in FIG. 13 may be used as the content reproducing apparatus according to the fourth embodiment. In the following description, it is assumed that the content reproducing apparatus shown in FIG. 1 is used.

It is assumed that the pixels of the downsampled right image data and the downsampled left image data are squeezed vertically, and the pixels in the right image are disposed in the upper half, while the pixels in the left image are disposed in the lower half to form a single frame shown in FIG. 12, and then compressed according to a predetermined image coding/compression scheme, and the compressed data is multiplexed with the audio data to form stream data, which is then stored in the content storage device 5.

During reproduction, the CPU 2 reads the stream data stored in the content storage device 5, and supplies the right image data D2R and the left image data D2L to the right image interpolation circuit 8a and the left image interpolation circuit 8b as in the first embodiment.

In the operation of the right image interpolation circuit 8a shown in FIG. 5, the right image interpolation data D2Ri is generated by the image interpolation data generating circuit 21 and supplied to the frame synthesizing circuit 22, as in the first embodiment.

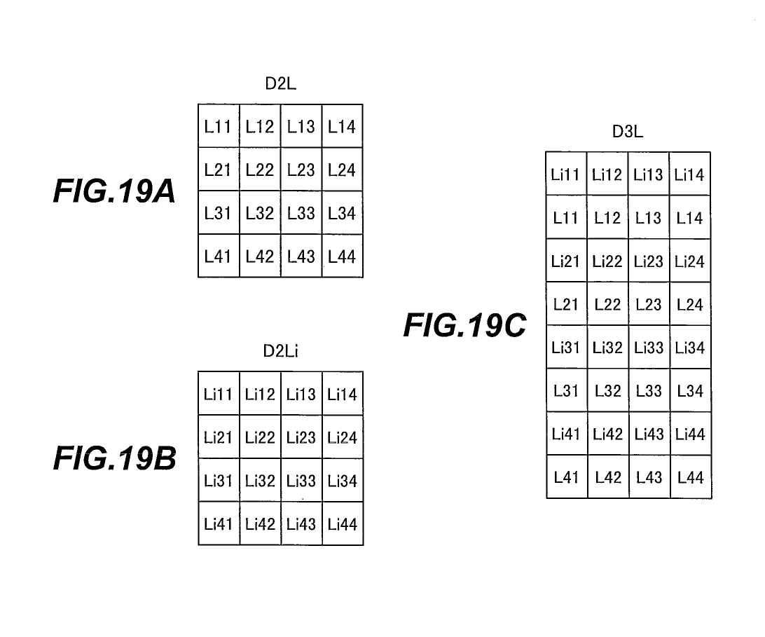

The frame synthesizing circuit 22 arranges the right image data D2R and the right image interpolation data D2Ri so that their pixels are disposed alternately in the vertical direction, i.e., the right image data D2R occupy alternate horizontal lines (rows) while the right image interpolation data D2Ri occupy the intervening horizontal lines (rows). The manner of the arrangement is shown in FIGS. 18A to 18C. These figures assume the regions of the size of 4×4 pixels, for simplicity of illustration, and illustrate the manner of synthesizing the right image data D2R (R11 to R44) of 4×4 pixel size shown in FIG. 18A and the right image interpolation data D2Ri (Ri11 to Ri44) of 4×4 pixel size shown in FIG. 18B to form interpolated right image data D3R of 8×4 pixel size shown in FIG. 18C. In the synthesis, the right image interpolation data (Ri11, Ri12, . . . ) are disposed at immediately below the corresponding right image data (R11, R12, . . . ). As a result, the pixels of the right image data D2R are disposed in alternate rows, while the pixels of the right image interpolation data D2Ri are disposed in intervening rows, and the interpolated right image data D3R has a vertical resolution which is doubled (and which is the same as the resolution before the downsampling). Among the interpolated right image data D3R, those corresponding to the right image data (R11, R12, . . . ) are at the same positions as the data of the pixels retained after the downsampling (i.e., the positions of the white parts in FIG. 17A), and those corresponding to the right image interpolation data (Ri11, Ri12, . . . ) are at the same positions as the data of the pixels removed by the downsampling (i.e., the positions of the hatched parts in FIG. 17A).

The left image interpolation circuit 8b is of the same configuration as the right image interpolation circuit 8a and performs the same operation as the right interpolation circuit 8a to produce interpolated left image data D3L, and the above description with reference to FIGS. 5 to 8, FIG. 17, and FIGS. 18A and 18 is also applicable, if the words “right” and “left” are interchanged, and the symbols “R” and “L” are interchanged in the description.

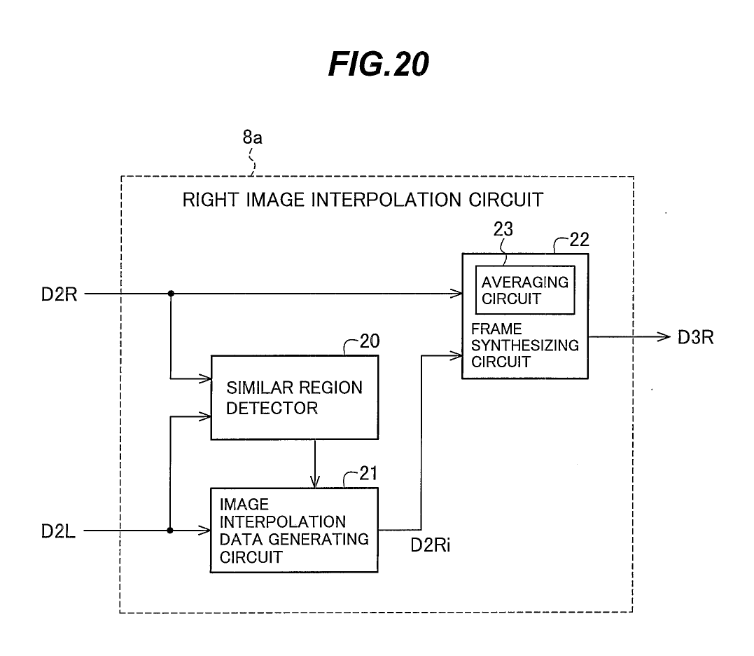

The operation of the frame synthesizing circuit 22 in the left image interpolation circuit 8b in the fourth embodiment is shown in FIGS. 19A to 19C.

The frame synthesizing circuit 22 in the left image interpolation circuit 8b arranges the left image data D2L and the left image interpolation data D2Li so that their pixels are disposed alternately in the vertical direction, i.e., the left image data D2L occupy alternate horizontal lines (rows) while the left image interpolation data D2Li occupy the intervening horizontal lines (rows). Like FIGS. 18A to 18C, FIGS. 19A to 19C assume the regions of the size of 4×4 pixels, and illustrate the manner of synthesizing the left image data D2L (L11 to L44) of 4×4 pixel size shown in FIG. 19A and the left image interpolation data D2Li (Li11 to Li44) of 4×4 pixel size shown in FIG. 19B to form interpolated left image data D3L of 8×4 pixel size shown in FIG. 19C. In the synthesis, the left image interpolation data (Li11, Li12, . . . ) is disposed immediately above the corresponding left image data (L11, L12, . . . ). As a result, the pixels of the left image data D2L are disposed in alternate rows, while the pixels of the left image interpolation data D2Li are disposed in intervening rows, and the interpolated left image data D3L has a vertical resolution which is doubled (and which is the same as the resolution before the downsampling). Among the interpolated left image data D3L, those corresponding to the left image data (L11, L12, . . . ) are at the same positions as the data of the pixels retained after the downsampling (i.e., the positions of the white parts in FIG. 17B), and those corresponding to the left image interpolation data (Li11, Li12, . . . ) are at the same positions as the data of the pixels removed by the downsampling (i.e., the positions of the hatched parts in FIG. 17B).

The operations subsequent to the output of the interpolated right image data D3R by the right image interpolation circuit 8a and the output of the interpolated left image data D3L by the left image interpolation circuit 8b are similar to those described in connection with the first embodiment. That is, the right output image data D3R and left output image data D3L are combined and displayed as described in the first embodiment.

According to the fourth embodiment, it is possible to obtain a high display quality when displaying a three-dimensional image content with the data size reduced by downsampling, as was also described in connection with the first embodiment.

The method described in connection with the fourth embodiment can be applied to a situation where the downsampled right image is made to form a single frame, and the downsampled left image is made to form another single frame, and the right and left images are compressed separately according to a predetermined image coding/compression scheme.

In the fourth embodiment, the pixels of the downsampled right image are disposed in the upper half while the pixels of the downsampled left image are disposed in the lower half. Alternatively, the pixels of the downsampled left image may be disposed in the upper half and the pixels of the downsampled right image may be disposed in the lower half.

### Fifth Embodiment

In this embodiment, when the similar region detector finds or determines that there is no comparison region which is similar to the reference region, an interpolation method different from that utilizing the corresponding region is used to conduct the interpolation.

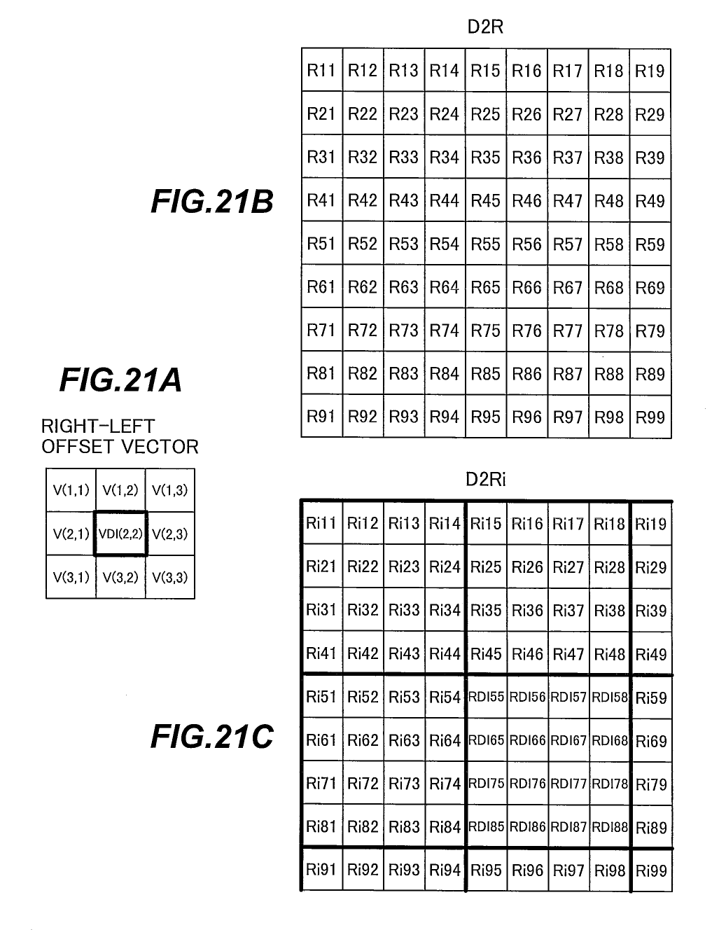

The content reproducing apparatus shown in FIG. 1 or the content reproducing apparatus shown in FIG. 13 may be used as the content reproducing apparatus according to the fifth embodiment. In the following description, it is assumed that the content reproducing apparatus shown in FIG. 1 is used. As the right image interpolation circuit 8a, the one shown in FIG. 20 is used. The right image interpolation circuit 8a shown in FIG. 20 is generally identical to that shown in FIG. 5, but differs from it in the following respects. The left image interpolation circuit 8b in the content reproducing apparatus according to the fifth embodiment is of a configuration similar to that of the right image interpolation circuit 8a.

When the similar region detector 20 determines that the maximum similarity calculated for the plurality of comparison regions (all the regions of the same size as the reference region, and positioned at the same vertical position as the reference region) is smaller than a predetermined threshold value, then the similar region detector 20 determines that there is no similar region and outputs data (flag) indicating that there is no similar region.

It may be so arranged that, when the similar region detector 20 determines that there is no similar region for each reference region, the interpolation data generating circuit 21 generates data indicating that the interpolation data is invalid, in place of the interpolation data for each pixel within the reference region.

In this case, when the frame synthesizing circuit 22 receives the data indicating that the interpolation data for each pixel (pixel of interest) is invalid, it performs interpolation using data of pixels surrounding the pixel of interest (the position at which the interpolated pixel is allocated). For instance, an average of the values of the pixels adjacent, in the upper, lower, leftward and rightward directions, to the pixel of interest may be used as the value of the interpolated pixel.

When the sum of the absolute differences, Ds, shown by equation (1) is used as an index of the similarity, a threshold value Dst is set in advance, and when no comparison region is found to yield the Ds value not larger than the threshold value Dst, a finding or determination that there is no similar region is made.

More detailed description is given below.

To simplify the following description, the size of the reference region and the comparison region used for the calculation of the similarity and the right-left offset vector will be assumed as 4×4 pixels. In practice, however, the size of the regions used in the fifth embodiment may be about 16×16 pixels as in the first to fourth embodiments.

As was described with reference to FIGS. 7A and 7B in connection with the first embodiment, the similar region detector 20 sequentially selects the comparison regions in the same vertical position as the reference region, and determines the sum of absolute differences, Ds, for each comparison region, and determines the minimum value Dsmin of the sums Ds.

The similar region detector 20 also compares the minimum value Dsmin with the threshold value Dst. Depending on the result of the comparison, the similar region detector outputs the right-left offset vector of the comparison region of which the sum of absolute differences Ds has been found to be the minimum, or data (flag) indicating that the right-left offset vector is invalid.

If the minimum sum of differences, Dsmin, is equal to or less than the threshold value Dst (i.e., Dsmin≦Dst), then the relative position (difference in the horizontal direction) of the region (the region of which the sum of absolute differences Ds is the minimum) within the left image data frame, to the position of the reference region within the right image data frame is output as the right-left offset vector.

If the minimum sum of differences, Dsmin, is greater than the threshold value Dst (i.e., Dsmin>Dst), the similar region detector 20 determines that there is no comparison region which has a sufficiently high similarity, and there is no valid right-left offset vector, and sets a flag or the like to indicate that the right-left offset vector for the reference region is invalid.

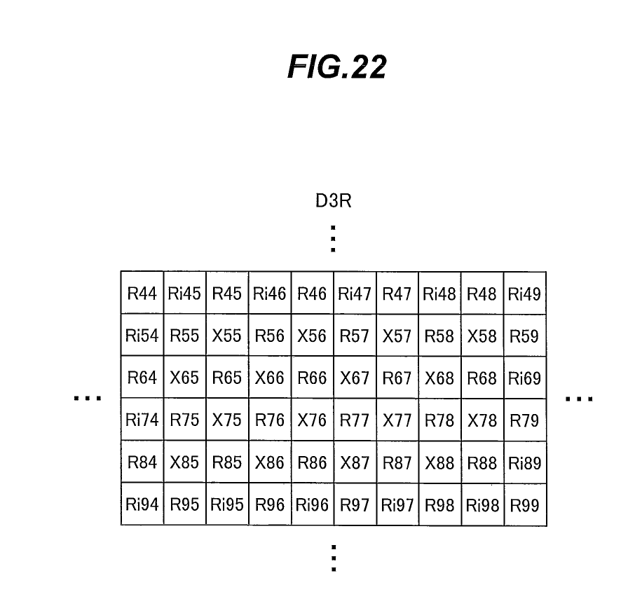

In the example shown in FIG. 21A, for the region in the second row from the top and second column from the left, data (flag) represented by VDI(2,2) is shown to be generated in place of the right-left offset vector V(2,2), to indicate that the right-left offset vector V(2,2) is invalid.

The image interpolation generating circuit 21 receives the input right-left offset vector V(2,2) or data VDI(2,2) indicating that the right-left offset vector is invalid, and left image data D2L contemporaneous with the data used for the right-left offset vector, and, based on the right-left offset vector V(m,n) determined for the region BR(m,n) of 4×4 pixels, extracts from the left image data, the pixel data of a region of 4×4 pixels at a position designated by the right-left offset vector (V,m) (at a relative position represented by the right-left offset vector V(m,n), with respect to the reference region), and arranges the extracted data in a region of the same size as the region BR(m,n) for which the right-left offset vector V(m,n) has been determined, to generate the right image interpolation data D2Ri (FIG. 21C).

With respect to the pixels contained in the region for which the right-left offset vector is invalid (region for which VDI(m,n) is generated in place of the right-left offset vector V(m,n)), the image interpolation generating circuit 21 sets a flag or the like to indicate that the right image interpolation data D2Ri in such a region (FIG. 21) is invalid.

In the example shown in FIG. 21C, RDIpq (p=5 to 8, q=5 to 8) are set to indicate that the right image interpolation data Ripq in the region in the second row from the top and in the second column from the left (the region of a size of 4×4 pixels, containing the fifth to eighth pixels from the left and the fifth to eighth pixels from the top) are invalid.

When invalid data is present in the right image interpolation data D2Ri in synthesizing a frame by arranging the pixels of the input right image data D2R (FIG. 21B) and the pixels of the right image interpolation data D2Ri (FIG. 21C) alternately in horizontal and vertical directions, the frame synthesizing circuit 22 calculates an average of the pixel values of the pixels adjacent, in the upper, lower, leftward and rightward directions, to the pixel of interest, in the arrangement of pixels after the interpolation, and uses the result of the calculation as the pixel value of the pixel of interest. The frame synthesizing circuit 22 includes an averaging circuit 23 to generate such an average interpolation data.

The pixels for which the interpolation data generated by the averaging circuit 23 are used in place of the data from the image interpolation data generating circuit 21 are indicated by symbols Xpq in FIG. 22. The equation used in the averaging circuit 23 to determine the average of the pixel values is shown below.

$$Xpq = \frac{R ( p - 1 ) q + R ( p + 1 ) q + Rpq + Rp ( q + 1 )}{4} \qquad ( 2 )$$

In the equation (2), R(p−1)q, R(p+1)q, Rpq, and Rp(q+1) respectively represent data of the pixels neighboring, in the upper, lower, leftward and rightward directions, (in the pixel arrangement after the interpolation) to the pixel Xpq for which interpolation is to be made,

In a color image, the Xpq calculation according to the equation (2) is performed separately for the different components of the image data (e.g., for the luminance, blue color difference, and red color difference components, or for the red, green, and blue components). The decision as to whether or not there is a similar region may be made for each component separately, or a combined decision may be made for all the components, depending on whether the Ds values are used separately or added together.

In the fifth embodiment as well, the left image interpolation circuit 8b is of the same configuration as the right image interpolation circuit 8a and operates in the same way as the right image interpolation circuit 8a to produce interpolated left image data D3L. The above description in connection with the first embodiment with reference to FIGS. 6 to 8, FIG. 20, FIGS. 21A to 21C, and FIG. 22 is applicable to the fifth embodiment if the words “right” and “left” are interchanged, and the reference symbols “R” and “L” are interchanged.

With the configuration described above, it is possible to obtain a high display quality when displaying a three-dimensional image content with data sized reduced by downsampling. In the above embodiment, the flags or the like are set to indicate that the right-left offset vector for the reference region in question is invalid. Alternatively, independent files or database may be used to indicate that the right-left offset vector for the reference region in question is invalid.

In the above embodiment, flags or the like are set for each pixel contained in the region for which the right-left offset vector is invalid to indicate that the data for the region in question of the right image interpolation data is invalid. Alternatively, independent files or database may be used to indicate that the right-left offset vector for the reference region in question is invalid.

Those skilled in the art will recognize that further variations are possible within the scope of the invention, which is defined in the appended claims.

What is claimed is:

1. A content reproducing apparatus that decodes a compressively coded right image downsampled by a factor of two and a compressively coded left image downsampled by a factor of two and generates output images for three-dimensional display, the content reproducing apparatus comprising:
an image decoding circuit configured to decode the compressively coded downsampled right image and the compressively coded downsampled left image to obtain a decoded right image and a decoded left image;
a similar region detector configured to detect, for each region of each of the decoded right image and the decoded left image, a region which is of the same size as said each region and which has image data similar to the image data of said each region;
an image interpolation data generating circuit configured to generate image interpolation data for each of the decoded right image and the decoded left image by extracting pixel data from the similar region; and
a frame synthesizing circuit configured to interpolate the image interpolation data into each of the decoded right image and the decoded left image.

2. The content reproducing apparatus of claim 1, wherein said similar region detector detects said region having image data similar to the image data of said each region in each of the decoded right image and the decoded left image, from the other of the decoded right image and the decoded left image.

3. The content reproducing apparatus of claim 1, wherein each of the downsampled compressively coded right image and the downsampled left image comprises an image consisting of pixels arranged in a checkerboard pattern, obtained by downsampling, from pixels arranged in a matrix pattern, every other pixel from each horizontal line and every other pixel from each vertical line, and
the frame synthesizing circuit interpolates the right image interpolation data into the decoded right image by disposing pixels from the decoded right image at alternate pixel positions in each horizontal row and each vertical column, and disposing pixels from the right image interpolation data at intervening pixel positions in each horizontal row and each vertical column, and interpolates the left image interpolation data into the decoded left image by disposing pixels from the decoded left image at alternate pixel positions in each horizontal row and each vertical column, and disposing pixels from the left image interpolation data at intervening pixel positions in each horizontal row and each vertical column.

4. The content reproducing apparatus of claim 1, wherein
each of the downsampled compressively coded right image and the downsampled compressively coded left image comprises an image obtained by downsampling, from pixels arranged in a matrix pattern, pixels in every other vertical line, and
the frame synthesizing circuit interpolates the right image interpolation data into the decoded right image by disposing pixels from the decoded right image in alternate vertical columns, and disposing pixels from the right image interpolation data in intervening vertical columns, and interpolates the left image interpolation data into the decoded left image by disposing pixels from the decoded left image in alternate vertical columns, and disposing pixels from the left image interpolation data in intervening vertical columns.

5. The content reproducing apparatus of claim 1, wherein
each of the compressively coded downsampled right image and the compressively coded downsampled left image comprises an image obtained by downsampling, from pixels arranged in a matrix pattern, pixels in every other horizontal line, and
the frame synthesizing circuit interpolates the right image interpolation data into the decoded right image by disposing pixels from the decoded right image in alternate horizontal rows, and disposing pixels from the right image interpolation data in intervening horizontal rows, and interpolates the left image interpolation data into the decoded left image by disposing pixels from the decoded left image in alternate horizontal rows, and disposing pixels from the left image interpolation data in intervening horizontal rows.

6. The content reproducing apparatus of claim 1, wherein the similar region detector compares each of a plurality of the regions at the same vertical position as said each region, and selects the region with the maximum similarity as said similar region.

7. The content reproducing apparatus of claim 6, wherein the similar region detector compares each of all the regions at the same vertical position as said each region, and selects the region with the maximum similarity as said similar region.

8. The content reproducing apparatus of claim 1, wherein when the similarity region detector determines that there is no region which has image data similar to the image data of each said region in each of the decoded right image and the decoded left image, the similar region detector generates data indicating that there is no similar region.

9. The content reproducing apparatus of claim 6, wherein if the maximum similarity is less than a predetermined threshold value, the similar region detector generates data indicating that there is no similar region.

10. The content reproducing apparatus of claim 8, wherein when the similarity region detector determines that there is no similar region, the image interpolation data generating circuit generates data indicating that the image interpolation data is invalid, in place of the image interpolation data for each pixel in said region.

11. The content reproducing apparatus of claim 10, wherein
when said frame synthesizing circuit receives said data indicating that the image interpolation data for each pixel is invalid, said frame synthesizing circuit performs interpolation using alternative interpolation data calculated from the data of pixels which will be, after the interpolation of said each pixel, in positions surrounding said each pixel, in place of the image interpolation data.

12. The content reproducing apparatus of claim 11, wherein
said frame synthesizing circuit uses, as said alternative interpolation data, an average value of the pixel values of the pixels which will be, after the interpolation, at positions neighboring and positioned above, below, to the left of, and to the right of said each pixel.

13. A content reproducing method that decodes a compressively coded right image downsampled by a factor of two and a compressively coded left image downsampled by a factor of two and generates output images for three-dimensional display, the content reproducing method comprising:
an image decoding step of decoding the compressively coded downsampled right image and the compressively coded downsampled left image to obtain a decoded right image and a decoded left image;
a similar region detecting step of detecting, for each region of each of the decoded right image and the decoded left image, a region which is of the same size as said each region and which has image data similar to the image data of said each region;
an image interpolation data generating step of generating image interpolation data for each of the decoded right image and the decoded left image by extracting pixel data from the similar region; and
a frame synthesizing step of interpolating the image interpolation data into each of the decoded right image and the decoded left image.

14. The content reproducing method of claim 13, wherein said similar region detecting step detects said region having image data similar to the image data of said each region in each of the decoded right image and the decoded left image, from the other of the decoded right image and the decoded left image.

15. The content reproducing method of claim 13, wherein
each of the compressively coded downsampled right image and the compressively coded downsampled left image comprises an image consisting of pixels arranged in a checkerboard pattern, obtained by downsampling, from pixels arranged in a matrix pattern, every other pixel from each horizontal line and every other pixel from each vertical line, and
the frame synthesizing step interpolates the right image interpolation data into the decoded right image by disposing pixels from the decoded right image at alternate pixel positions in each horizontal row and each vertical column, and disposing pixels from the right image interpolation data at intervening pixel positions in each horizontal row and each vertical column, and interpolates the left image interpolation data into the decoded left image by disposing pixels from the decoded left image at alternate pixel positions in each horizontal row and each vertical column, and disposing pixels from the left image interpolation data at intervening pixel positions in each horizontal row and each vertical column.

16. The content reproducing method of claim 13, wherein
each of the compressively coded downsampled right image and the compressively coded downsampled left image comprises an image obtained by downsampling, from pixels arranged in a matrix pattern, pixels in every other vertical line, and
the frame synthesizing step interpolates the right image interpolation data into the decoded right image by disposing pixels from the decoded right image in alternate vertical columns, and disposing pixels from the right image interpolation data in intervening vertical columns, and interpolates the left image interpolation data into the decoded left image by disposing pixels from the decoded left image in alternate vertical columns, and disposing pixels from the left image interpolation data in intervening vertical columns.

17. The content reproducing method of claim 13, wherein
each of the compressively coded downsampled right image and the compressively coded downsampled left image comprises an image obtained by downsampling, from pixels arranged in a matrix pattern, pixels in every other horizontal line, and
the frame synthesizing step interpolates the right image interpolation data into the decoded right image by disposing pixels from the decoded right image in alternate horizontal rows, and disposing pixels from the right image interpolation data in intervening horizontal rows, and interpolates the left image interpolation data into the decoded left image by disposing pixels from the decoded left image in alternate horizontal rows, and disposing pixels from the left image interpolation data in intervening horizontal rows.

18. The content reproducing method of claim 13, wherein the similar region detecting step compares each of a plurality of the regions at the same vertical position as said each region, and selects the region with the maximum similarity as said similar region.

19. The content reproducing method of claim 18, wherein the similar region detecting step compares each of all the regions at the same vertical position as said each region, and selects the region with the maximum similarity as said similar region.

20. The content reproducing method of claim 13, wherein when the similarity region detecting step determines that there is no region which has image data similar to the image data of each said region in each of the decoded right image and the decoded left image, the similar region detecting step generates data indicating that there is no similar region.

21. The content reproducing method of claim 18, wherein if the maximum similarity is less than a predetermined threshold value, the similar region detecting step generates data indicating that there is no similar region.

22. The content reproducing method of claim 20, wherein when the similarity region detecting step determines that there is no similar region, the image interpolation data generating step generates data indicating that the image interpolation data is invalid, in place of the image interpolation data for each pixel in said region.

23. The content reproducing method of claim 22, wherein
when said frame synthesizing step receives said data indicating that the image interpolation data for each pixel is invalid, said frame synthesizing step performs interpolation using alternative interpolation data calculated from the data of pixels which will be, after the interpolation of said each pixel, in positions surrounding said each pixel, in place of the image interpolation data.

24. The content reproducing method of claim 23, wherein
said frame synthesizing step uses, as said alternative interpolation data, an average value of the pixel values of the pixels which will be, after the interpolation, at positions neighboring and positioned above, below, to the left of, and to the right of said each pixel.
